(19) United States
(12) Patent Application Publication
(10) Pub. No.: US 2022/0151203 A1
(43) Pub. Date: May 19, 2022

(54) Pet Drinking Fountain

(71) Applicant: Douglas Milton, Hackensack, NJ (US)

(72) Inventor: Douglas Milton, Hackensack, NJ (US)

(21) Appl. No.: 16/950,709

(22) Filed: Nov. 17, 2020

(51) Int. Cl. A01K 7/06; A01K 7/02

(52) U.S. Cl. CPC A01K 7/06; A01K 7/025

(57) ABSTRACT

The pet drinking fountain allows pets to have a source of running water whenever they desire, but without having to constantly run the water. The pets can learn to press the frontal pedal of the fountain bowl to open the cover and begin the running water. Then, once the pet has finished drinking, they can release the pedal to stop the water from needlessly running and to shut the cover again for cleanliness. The pet drinking fountain is anchored to the ground to prevent the pet from moving its location. Additionally, it requires a water source and disposal to continue to provide clean water for the pet.

### BACKGROUND

A drinking fountain, also called a water fountain or bubbler, is a fountain designed to provide drinking water. It consists of a basin with either continuously running water or a tap. The drinker bends down to the stream of water and swallows water directly from the stream. Modern indoor drinking fountains may incorporate filters to remove impurities from the water and chillers to lower its temperature. There have been no products available as original equipment or as an aftermarket to address this problem.

In the wild animals prefer to drink from running stream or river water than stagnant water. Stagnant water is water that has been sitting in one spot for long periods of time; this water can become dirty quite quickly and is much more likely to harbour bacteria and parasites. Running water is usually cooler and more oxygenated than sitting water, it also won't harbour as many particles that could sit at the bottom of a bowl and give the water a bad taste. There have been no products available as original equipment or as an aftermarket to address this problem either.

There exists a need for a pet drinking fountain that is not being met by any known or disclosed device or system of present.

### SUMMARY OF THE INVENTION

The pet drinking fountain allows pets to have a source of running water whenever they desire, but without having to constantly run the water. The pets can learn to press the frontal pedal of the fountain bowl to open the cover and begin the running water. Then, once the pet has finished drinking, they can release the pedal to stop the water from needlessly running and to shut the cover again for cleanliness. The pet drinking fountain is anchored to the ground to prevent the pet from moving its location. Additionally, it requires a water source and disposal to continue to provide clean water for the pet.

### BRIEF DESCRIPTION OF THE DRAWINGS

FIG. 1 is a view of the pet drinking fountain in accordance with an embodiment of the present disclosure.

FIG. 2 is a view of the pet drinking fountain with a perforated cover in accordance with an embodiment of the present disclosure.

FIG. 3 is a flow chart of a method for providing a drink for a pet in accordance with an embodiment of the present disclosure.

FIG. 4 is a flow chart of additional methods for providing a drink for a pet in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term ‘filter’ is used to refer to water being passed over small holes and also including the filter passed over the water to catch particles larger than the small holes which include millimeter and micrometer dimensions.

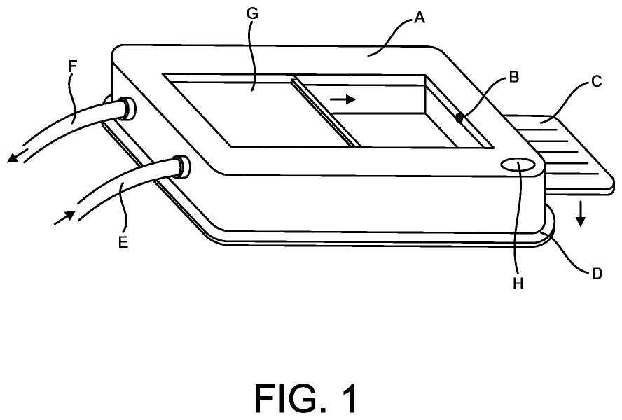

FIG. 1 is a view of the pet drinking fountain with a solid cover in accordance with an embodiment of the present disclosure. The pet can drink water out of the bowl A or directly from the fountain B. Pressing on the pedal C in the front causes the solid sliding cover G to reveal the water and causes the fountain to run. However, due to the potential of false activation, there is a sensor H, to shut off the water and close the cover again if no pet is detected. The pet drinking fountain is permanently anchored D and receives two tubes for water, one tube for water input E, and another tube for water drain F.

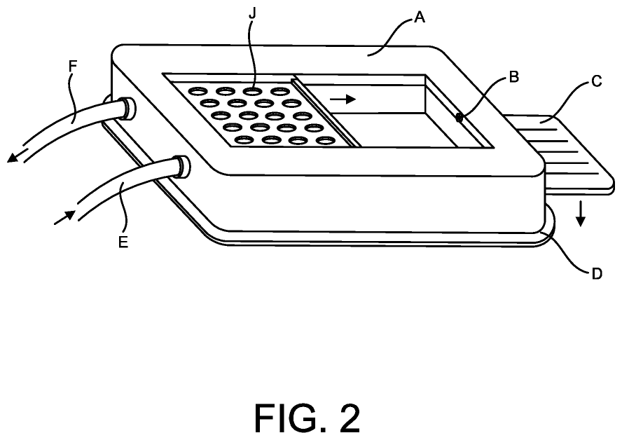

FIG. 2 is a view of the pet drinking fountain with a perforated cover in accordance with an embodiment of the present disclosure. The pet can drink water out of the bowl A or directly from the fountain B. Pressing on the pedal C in the front causes the sliding cover G to reveal the water and causes the fountain to run. However, due to the potential of false activation, there is a sensor H, to shut off the water and close the cover again if no pet is detected. The pet drinking fountain is permanently anchored D and receives two tubes for water, one tube for water input E, and another tube for water drain F. The sliding cover J is perforated or riddled with openings from which water in the reservoir can come and go and thereby filter across the cover. An inline filter is also included in embodiments, the inline filter associated with the pet drinking fountain adjacent a water source and also adjacent the pet drinking fountain as well.

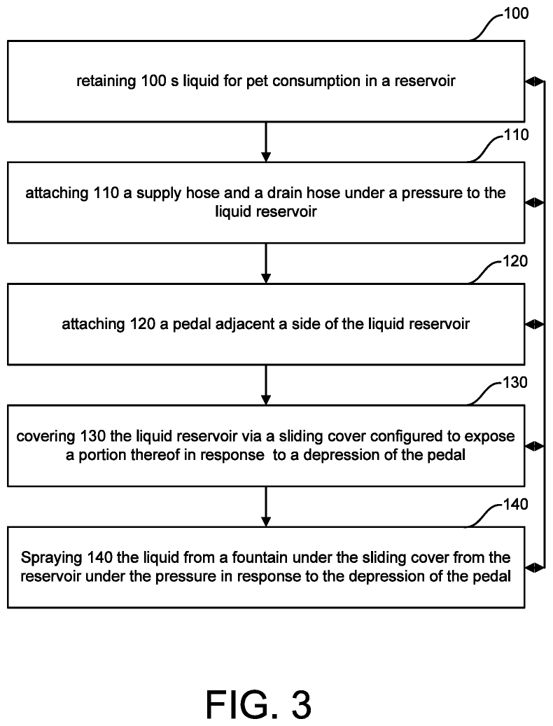

FIG. 3 is a flow chart of a method for providing a drink for a pet in accordance with an embodiment of the present disclosure. The method includes retaining 100 a liquid for pet consumption in a reservoir. The method also includes attaching 110 a supply hose and a drain hose under a pressure to the liquid reservoir. The method additionally includes attaching 120 a pedal adjacent a side of the liquid reservoir. The method further includes covering 130 the liquid reservoir via a sliding cover configured to expose a portion thereof in response to a depression of the pedal. The method yet includes spraying 140 the liquid from a fountain under the sliding cover from the reservoir under the pressure in response to the depression of the pedal.

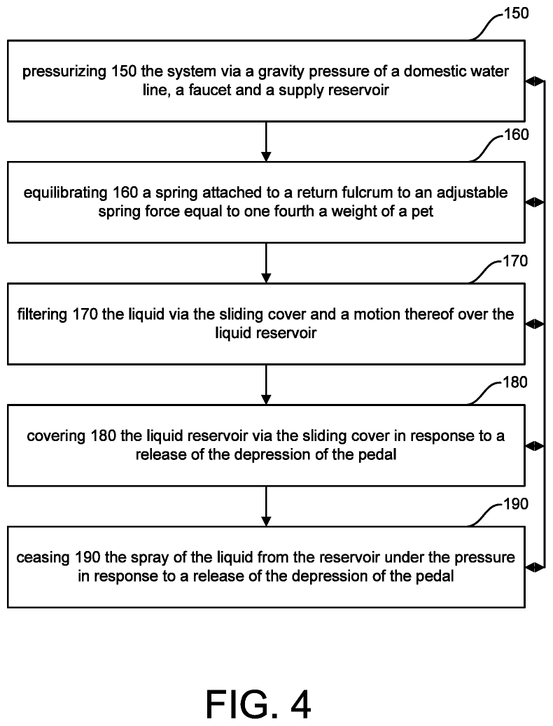

FIG. 4 is a flow chart of additional methods for providing a drink for a pet in accordance with an embodiment of the present disclosure. The additional methods includes pressurizing 150 the system via a gravity pressure of a domestic water line, a faucet and a supply reservoir. The additional methods also include equilibrating 160 a spring attached to a return fulcrum to an adjustable spring force equal to one fourth a weight of a pet. The additional methods additionally include filtering 170 the liquid via the sliding cover and a motion thereof over the liquid reservoir. The additional methods further include covering 180 the liquid reservoir via the sliding cover in response to a release of the depression of the pedal. The additional methods further include ceasing 190 the fountain spray of the liquid from the reservoir under the pressure in response to a release of the depression of the pedal.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A pet drinking fountain comprising:
a liquid reservoir configured to retain a liquid for a pet consumption;
a supply hose and a drain hose attached under a pressure to the liquid reservoir;
a pedal attached adjacent a side of the liquid reservoir;
a sliding cover configured to cover the liquid reservoir and to expose a portion thereof in response to a depression of the pedal;
a fountain under the sliding cover and configured to spray a liquid from the reservoir under the pressure in response to the depression of the pedal.

2. The pet drinking fountain of claim 1, further comprising a sticky pad anchor on a footprint of the liquid reservoir.

3. The pet drinking fountain of claim 1, wherein the pressure is a gravity pressure of a domestic water line, a faucet and a supply reservoir.

4. The pet drinking fountain of claim 1, wherein the pedal is attached to spring loaded return.

5. The pet drinking fountain of claim 1, wherein a spring attached to a return fulcrum has an adjustable spring force equal to one fourth a weight of a domestic animal.

6. The pet drinking fountain of claim 1, wherein the sliding cover defines a perforated surface.

7. The pet drinking fountain of claim 1, wherein the sliding cover defines a plurality of holes in a surface thereof.

8. The pet drinking fountain of claim 1, wherein the sliding cover comprises a filter disposed between a liquid in the liquid reservoir and an outside surface of the cover.

9. The pet drinking fountain of claim 1, wherein the fountain is disposed adjacent the pedal and under the cover.

10. The pet drinking fountain of claim 1, wherein the sliding cover is configured to cover the liquid reservoir in response to a release of the depression of the pedal.

11. The pet drinking fountain of claim 1, wherein the fountain is configured to cease the spray of the liquid from the reservoir under the pressure in response to a release of the depression of the pedal.

12. The pet drinking fountain of claim 1, further comprising a mechanical timer configured to trigger a deactivation of the fountain and to close the cover.

13. The pet drinking fountain of claim 1, further comprising a proximity sensor configured to trigger a deactivation of the fountain and to close the cover.

14. The pet drinking fountain of claim 1, further comprising a trigger to recycle the fluid in the reservoir through the supply and drain hoses in response to a closure of the cover.

15. A method of providing a drink for a pet, the method comprising:
retaining a liquid for pet consumption in a reservoir;
attaching a supply hose and a drain hose under a pressure to the liquid reservoir;
attaching a pedal adjacent a side of the liquid reservoir;
covering the liquid reservoir via a sliding cover configured to expose a portion thereof in response to a depression of the pedal; and
spraying the liquid from a fountain under the sliding cover from the reservoir under the pressure in response to the depression of the pedal.

16. The method of claim 15, further comprising pressurizing the system via a gravity pressure of a domestic water line, a faucet and a supply reservoir.

17. The method of claim 15, further comprising equilibrating a spring attached to a return fulcrum to an adjustable spring force equal to one fourth a weight of a pet.

18. The method of claim 15, further comprising filtering the liquid via the sliding cover and a motion thereof over the liquid reservoir.

19. The method of claim 15, further comprising covering the liquid reservoir via the sliding cover in response to a release of the depression of the pedal.

20. The method of claim 15, further comprising ceasing the fountain spray of the liquid from the reservoir under the pressure in response to a release of the depression of the pedal.
